(19) United States
(12) Patent Application Publication
(10) Pub. No.: US 2026/0285702 A1
(43) Pub. Date: Sep. 24, 2026

(54) PROCESS FOR EXTRACTING NICKEL FROM GASIFIER SLAG

(71) Applicant: RELIANCE INDUSTRIES LIMITED, Mumbai (IN)

(72) Inventors: VENKATANARASIMHA RAO CHELLI, Khammam (IN); SATEESH DAGGUPATI, Khammam (IN); AJAY JHA, Varanasi (IN); NIBEDITA SANYAL, Kolkata (IN); SUDHIR PATEL, Vadodara (IN); KALPESH GIRACHH, Ankaleswar (IN); SUKUMAR MANDAL, Faridabad (IN); ASIT DAS, Faridabad (IN)

(73) Assignee: RELIANCE INDUSTRIES LIMITED, Mumbai (IN)

(21) Appl. No.: 19/567,934

(22) Filed: Mar. 16, 2026

(30) Foreign Application Priority Data
Mar. 19, 2025 (IN) 202521024649

(51) Int. Cl. C01G 53/04; C22B 3/00; C22B 3/16; C22B 3/30

(52) U.S. Cl. CPC C01G 53/04; C22B 3/16; C22B 3/30; C22B 23/0415; C22B 23/0453; C01P 2006/80

(57) ABSTRACT

The present disclosure relates to a process of extracting nickel from gasifier slag. The process integrates salt roasting with leaching to maximize nickel extraction from the gasifier slag. The leaching is performed in two stages, utilizing a chelating agent and an acidic solution as a chelating agent to optimize nickel recovery. The process of the present disclosure consumes minimum chemicals and additives and achieves nickel production with a purity of up to 99%, ensuring high-quality output and superior performance. The process of the present disclosure is simple to perform, energy-efficient and commercially viable as intermediate streams are recyclable.

### FIELD

The present disclosure relates to nickel production. Particularly, the present disclosure relates to a process for extracting nickel from gasifier slag.

### Definitions

As used in the present disclosure, the following terms are generally intended to have the meaning as set forth below, except to the extent that the context in which they are used, indicate otherwise.

Gasifier slag: The term “gasifier slag” is also known as carbonaceous feed gasification slag (CGS), which is a solid waste produced during the process for gasification of carbonaceous feedstocks, wherein the gasifier slag contains residual carbon, inorganic material and various types of metal such as nickel, silica, alumina, calcium, vanadium, iron and the like.

Leaching: The term “leaching” relates to a process that extracts a substance from a solid material by dissolving the solid in an aqueous solution.

### BACKGROUND

The background information herein below relates to the present disclosure but is not necessarily prior art.

Carbonaceous feedstock (such as petcoke, coal and the like or their mixtures) undergoes conversion in a gasifier under high-temperature (T>1300° C.) and high-pressure (P>20 bar) conditions i.e., above melting point temperatures of inorganics content, where its inorganic content forms molten slag, and carbon is converted into syngas. To ensure proper flowability of the molten slag, fluxes like limestone and fly ash are added to lower the ash fusion temperature. The slag's composition is a complex mix of inorganic elements from the feedstock and flux, with metals embedded in a stable matrix, typically in a reduced state with a spinel structure. This slag contains approximately key metals such as 5 wt. % vanadium (V), 2 wt. % nickel (Ni), 16 wt. % silicon (Si), 10 wt. % aluminum (Al), 12 wt. % calcium (Ca), and 5 wt. % iron (Fe), which has various industrial applications such as in ferroalloys, petroleum refining (as catalysts), and battery production. Despite these applications, the primary source of nickel, derived from spent catalysts, ores, and metallurgical slags, is limited. Moreover, about 70% of nickel is used in ferroalloys, with demand growing at a rate of ~7%.

The conventional processes used for the extraction of nickel are complex and have a higher impact on the environment and also use large quantities of chemicals and additives. In one such process used for the extraction of nickel from spent metals laden hydro refining catalyst containing nickel, the spent catalyst is heated in the presence of air to remove carbonaceous and sulfurous matter, followed by ammonium carbonate leaching. While the process achieves a maximum recovery of about 80% nickel, it is less effective at temperatures below 600° C. (recovery less than 50%). Additionally, the process requires a large quantity of ammonium carbonate, which is costly and not feasible for large-scale commercialization.

In another technique, an ultrasonic-assisted leaching with EDTA is used to extract nickel from spent catalysts, such a process can recover up to 97% of nickel. However, it requires a high solid-to-liquid ratio (1:40) which leads to the need for larger reactor volumes and increased consumption of EDTA. This makes the process less efficient and more resource-intensive, raising concerns about its scalability and cost-effectiveness.

In yet another nickel extraction process, the process uses ammonia and LIX 84i as an extracting agent and recovers nickel in multiple stages. While it efficiently recovers nickel in multiple stages, the process involves a complex multi-step operation, including scrubbing and stripping stages with concentrated sulfuric acid. This increases operational complexity, energy consumption, and the need for specialized equipment. Further, due to the use of the scrubbing and the stripping chamber, mixing and settling of the nickel occurs in both chambers and the aqueous phase containing the nickel sulphate solution.

Therefore, conventional processes are not feasible and efficient in recovering the nickel from gasifier slag or spent catalysts. In addition, this spent catalyst is prepared by doping nickel on the supports such as alumina. The extraction of nickel from these supports are simpler task as they are not chemically bonded or entrapped with other metals in a spinel structure like slag. These conventional processes require large quantities of chemicals (ammonium carbonate, EDTA, sulfuric acid) that are costly and make the processes less economically viable for large-scale applications. Further, high energy consumption and large reactor volumes increase operational costs. Some processes suffer from lower recovery rates at lower temperatures or require very specific conditions that limit their scalability. These limitations highlight the need for more efficient, cost-effective, and environmentally friendly methods to extract nickel from spent catalysts, ores, and slags. There is, therefore, felt a need to provide a process for extracting nickel from gasifier slag that overcomes the above-mentioned drawbacks, or at least provides an alternative solution.

### OBJECTS

Some of the objects of the present disclosure, which at least one embodiment herein satisfies, are as follows:

An object of the present disclosure is to ameliorate one or more problems of the background or to at least provide a useful alternative.

Another object of the present disclosure is to provide a process for extracting nickel from gasifier slag.

Still, another object of the present disclosure is to provide a process for extracting nickel from gasifier slag that consumes minimum chemicals and additives.

Yet another object of the present disclosure is to provide a process for extracting nickel from gasifier slag that achieves nickel production with a purity of up to 98.9%.

Still, another object of the present disclosure is to provide a process for extracting nickel from gasifier slag that is simple to perform and energy efficient.

Still, another object of the present disclosure is to provide a process for extracting nickel from gasifier slag that recycles all intermediate streams and thus makes the process commercially viable.

Yet another object of the present disclosure is to provide a process for extracting nickel from gasifier slag that maximizes the recovery of nickel from the complex gasifier slag feed.

Other objects and advantages of the present disclosure will be more apparent from the following description, which is not intended to limit the scope of the present disclosure.

### SUMMARY

The present disclosure relates to a process for extracting nickel from gasifier slag, the process comprising the following steps:
i. leaching a pulverized gasifier slag in a chelating agent and water at a first predetermined temperature for a first predetermined time, followed by filtering to obtain a first leachate solution comprising an aqueous nickel-chelating agent complex and a first solid residue;
ii. precipitating the first leachate solution comprising the aqueous nickel-chelating agent complex by using a first acidic solution, followed by filtering to obtain a precipitated chelating agent and a second leachate solution comprising nickel-containing aqueous solution;
iii. leaching the first solid residue in a second acidic solution at a second predetermined temperature for a second predetermined time under continuous stirring followed by filtering to obtain a third leachate solution comprising an aqueous nickel-acid complex and a second solid residue;
iv. treating the third leachate solution comprising the aqueous nickel-acid complex by using an organic solvent to obtain a first biphasic mixture comprising an organic layer of a nickel-solvent complex and an aqueous layer;
v. separating the organic layer of a nickel-solvent complex and treating by using a third acidic solution to obtain a second biphasic mixture comprising a nickel-containing aqueous phase and the organic solvent phase;
vi. separating nickel-containing aqueous phase from the second biphasic mixture to obtain a separated nickel-containing aqueous phase;
vii. treating the second leachate solution obtained in step ii) and the separated nickel-containing aqueous phase obtained in step vi) by using an alkali hydroxide under continuous stirring to obtain a slurry comprising a precipitate of nickel hydroxide and an aqueous solution; and
viii. separating the nickel hydroxide precipitate followed by drying and calcinating at a third predetermined temperature for a third predetermined time period to obtain nickel in the form of nickel oxide.

In an embodiment, the pulverized gasifier slag has a particle size of less than 45 μm.

In an embodiment, the pulverized gasifier slag is obtained by:
a. roasting a gasifier slag with an alkali salt at a temperature in the range of 800° C. to 1100° C. for a time period in the range of 1 hour to 5 hours in the presence of air to obtain a roasted slag; and
b. leaching the roasted slag in water heated at a temperature in the range of 60° C. to 120° C. for a time period in the range of 1 hour to 4 hours, followed by filtering and pulverizing to obtain the pulverized gasifier slag enriched with nickel and a solution containing alkali metal salts.

In an embodiment, the alkali salt is at least one selected from the group consisting of sodium carbonate (Na₂CO₃), sodium hydroxide (NaOH) and sodium sulfate (Na₂SO₄).

In an embodiment, the precipitated chelating agent obtained in step ii is recycled to step i for the extraction of nickel from the pulverized gasifier slag; the aqueous layer obtained in step iv is recycled to step iii for extracting nickel from the first solid residue; the organic solvent phase obtained in step v is recycled to step iv for treating the third leachate solution comprising the aqueous nickel-acid complex; and the aqueous solution obtained in step vii is recycled to step i for the extraction of nickel from the pulverized gasifier slag.

In an embodiment, leaching of the pulverized gasifier slag in the chelating agent is carried out by maintaining pH in the range of 8 to 10.

In an embodiment, a weight ratio of the pulverized gasifier slag to the chelating agent is in the range of 1:1 to 5:1.

In an embodiment, a weight ratio of the pulverized gasifier slag to water in the step (i) is in the range of 1:2 to 1:5.

In an embodiment, a weight ratio of the first solid residue to the second acidic solution in step (iii) is in the range of 1:2 to 1:5.

In an embodiment, the amount of the second acid is in the range of 20 wt % to 60 wt % with respect to the total weight of the second acidic solution.

In an embodiment, the precipitated chelating agent is recovered by maintaining the pH of the first leachate solution comprising an aqueous nickel-chelating agent in the range of 1 to 5; wherein the pH is maintained by using the first acidic solution.

In an embodiment, the first solid residue and the second solid residue contain nickel, silica, alumina, calcium, iron and magnesium.

In an embodiment, the chelating agent is selected from the group consisting of Ethylenediaminetetraacetic acid (EDTA), Dimethylglyoxime (DMG), and diethylenetriamine penta acetic acid (DTPA).

In an embodiment, the first predetermined temperature is in the range of 60° C. to 160° C. and the first predetermined time period is in the range of 2 hours to 8 hours.

In an embodiment, the first acidic solution, the second acidic solution and the third acidic solution are independently selected from nitric acid (HNO₃), sulphuric acid (H₂SO₄) and mixtures thereof.

In an embodiment, the alkali hydroxide is at least one selected from the group consisting of sodium hydroxide (NaOH), Magnesium hydroxide (Mg(OH)₂) and potassium hydroxide (KOH).

In an embodiment, the organic solvent is used as an extraction agent for extracting nickel from the third leachate solution comprising the aqueous nickel-acid complex, wherein the organic solvent is selected from 2-hydroxy-5-nonylaceto-phenone oxime, 1-phenyl-3-hydroxy-4-oxime-5-pyrazolone, 1-phenyl-3,5-dimethyl-4-oxime-5-pyrazolone and 1-phenyl-3-methyl-4-oxime-5-pyrazolone.

In an embodiment, the nickel is recovered from the nickel-solvent complex by lowering the pH of the nickel-solvent complex in the range of 1 to 5 by using the third acidic solution.

In an embodiment, the precipitation in step vii is carried out by maintaining pH in the range of 8 to 12 to obtain the slurry comprising the precipitate of nickel hydroxide.

In an embodiment, the second predetermined temperature is in the range of 40° C. to 140° C. and the second predetermined time period is in the range of 2 hours to 6 hours.

In an embodiment, the third predetermined temperature is in the range of 100° C. to 300° C. and the third predetermined time period is in the range of 1 hour to 5 hours.

In an embodiment, the process is a continuous process of extraction of the nickel in the oxide form from the pulverized gasifier slag.

In an embodiment, the extracted nickel has a recovery rate in the range of 15% to 80% and purity in the range of 50% to 99%.

### BRIEF DESCRIPTION OF THE ACCOMPANYING DRAWINGS

A process for the extraction of nickel from gasifier slag of the present disclosure will now be described with the help of the accompanying drawing, in which:

FIG. 1 illustrates a schematic representation of a salt-roasting process for the preparation of pulverized gasifier slag.

FIG. 2 illustrates a schematic representation of a process for extracting nickel from the pulverized gasifier slag in accordance with an embodiment of the present disclosure.

FIG. 3 illustrates the process of extracting nickel in accordance with the present disclosure.

### LIST OF REFERENCE NUMERALS USED IN DETAILED DESCRIPTION AND DRAWING

| Reference no. | Reference |
|---|---|
| 1000 | a process for extracting nickel from gasifier slag |
| 10 | gasifier slag |
| 20 | slag grinding |
| 30 | alkali salt |
| 40 | water |
| 50 | soaking |
| 60 | air |
| 100 | roasting of gasifier slag |
| 200 | water leaching |
| 250 | filtering |
| 280 | pulverized gasifier slag |
| 290 | solution containing alkali metal salt |
| 300 | leaching of pulverized gasifier slag |
| 350 | filtering to obtain the first solid residue |
| 360 | recycled stream of EDTA solution |
| 380 | first solid residue |
| 400 | precipitation of the first leachate solution |
| 450 | filtering to obtain precipitated EDTA |
| 460 | first acidic solution |
| 470 | second leachate solution |
| 490 | precipitated chelating agent (EDTA) |
| 500 | leaching of the first solid residue |
| 550 | filtering to obtain the third leachate solution |
| 560 | second acidic solution |
| 580 | second solid residue |
| 590 | purge solid |
| 600 | treating third leachate solution |
| 650 | separating organic layer |
| 670 | nickel solvent complex |
| 690 | aqueous layer |
| 700 | treating nickel solvent complex |
| 750 | separating nickel-containing aqueous phase |
| 760 | third acidic solution |
| 770 | separated nickel-containing aqueous phase |
| 790 | recycled organic solvent phase |
| 800 | treating solutions containing nickel (470, 770) |
| 850 | filtering to obtain a precipitate of nickel hydroxide |
| 860 | alkali hydroxide |
| 870 | nickel hydroxide precipitate |
| 890 | aqueous solution |
| 900 | drying |
| 950 | calcination to obtain nickel oxide |
| 970 | nickel in the form of oxide |

### DETAILED DESCRIPTION

The present disclosure relates to a process for extracting nickel from gasifier slag.

Embodiments of the present disclosure will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section.

Terms such as first, second, third, etc., when used herein do not imply a specific sequence or order unless clearly suggested by the present disclosure.

When an element is referred to as being “mounted on”, “engaged to”, “connected to” or “coupled to” another element, it may be directly on, engaged, connected or coupled to the other element. As used herein, the term “and/or” includes any and all combinations of one or more of the associated listed elements.

Terms such as “inner”, “outer”, “beneath”, “below”, “lower”, “above”, “upper” and the like, may be used in the present disclosure to describe relationships between different elements as depicted from the figures.

Carbonaceous feedstock (such as petcoke, coal and the like or their mixture) is converted in a gasifier under high-temperature (T>1300° C.) and high-pressure (P>20 bar) conditions i.e. above melting point temperatures of inorganics content, where the inorganic components form molten slag and carbon is converted into syngas. To maintain the proper flowability of the molten slag, fluxes like limestone and fly ash are added to lower the ash fusion temperature. The slag's composition consists of a complex mixture of inorganic elements from the feedstock and flux, with metals embedded in a stable matrix, often in a reduced state and forming a spinel structure. This slag contains approximately key metals such as 5 wt. % vanadium (V), 2 wt. % nickel (Ni), 16 wt. % silicon (Si), 10 wt. % aluminum (Al), 12 wt. % calcium (Ca), and 5 wt. % iron (Fe), which has various industrial applications, such as in ferroalloys, petroleum refining (as catalysts), and battery production. However, the main source of nickel, derived from spent catalysts, ores, and metallurgical slags, is limited. About 70% of nickel is used in ferroalloys, and the demand is growing at approximately 7% annually.

The traditional methods used for nickel extraction are complex and detrimental to the environment, requiring large quantities of chemicals and additives. In one such method for extracting nickel from spent catalysts laden with hydro-refining metals, the spent catalyst must be heated in air to remove carbonaceous and sulfurous materials, followed by ammonium carbonate leaching. While this process can achieve up to 80% nickel recovery, its efficiency drops significantly below 600° C. (with recovery rates under 50%). Additionally, it demands a substantial amount of ammonium carbonate, which is expensive and not viable for large-scale commercial use.

Another method uses ultrasonic-assisted leaching with EDTA to extract nickel from spent catalysts, achieving up to 97% recovery. However, this approach requires a high solid-to-liquid ratio (1:40), which increases reactor volume requirements and leads to higher EDTA consumption. This makes the process less efficient and resource-intensive, raising concerns about scalability and cost-effectiveness.

In a separate nickel extraction process, ammonia and LIX 84i are used as extracting agents in a multi-stage recovery operation. While this method efficiently recovers nickel, it involves a complex series of steps, including scrubbing and stripping with concentrated sulfuric acid, which adds to operational complexity, increases energy consumption, and necessitates specialized equipment. Furthermore, the process requires mixing and settling in the scrubbing and stripping chambers, resulting in an aqueous phase containing nickel sulfate.

As a result, these conventional methods are neither practical nor efficient for recovering nickel from gasifier slag. These conventional processes require large quantities of chemicals (ammonium carbonate, EDTA, sulfuric acid), making the processes economically unfeasible for large-scale applications. The high energy consumption and need for large reactors further drive up operational costs. Additionally, some methods exhibit reduced efficiency at lower temperatures or require highly specific conditions, limiting their scalability. These challenges underscore the need for more efficient, cost-effective, and environmentally friendly methods for extracting metals from spent catalysts, ores, and slags.

In an aspect, the present disclosure provides a process (1000) for extracting nickel from gasifier slag (10), the process (1000) comprises the following steps:
i. leaching (300) a pulverized gasifier slag (280) in a chelating agent (360) and water at a first predetermined temperature for a first predetermined time, followed by filtering (350) to obtain a first leachate solution comprising an aqueous nickel-chelating agent complex and a first solid residue (380);
ii. precipitating (400) the first leachate solution comprising the aqueous nickel-chelating agent complex by using a first acidic solution (460), followed by filtering (450) to obtain a precipitated chelating agent (490) and a second leachate solution (470) comprising nickel-containing aqueous solution;
iii. leaching (500) the first solid residue (380) in a second acidic solution (560) at a second predetermined temperature for a second predetermined time under continuous stirring followed by filtering (550) to obtain a third leachate solution comprising an aqueous nickel-acid complex and a second solid residue (580);
iv. treating (600) the third leachate solution comprising the aqueous nickel-acid complex by using an organic solvent (790) to obtain a first biphasic mixture comprising an organic layer of a nickel-solvent complex (670) and an aqueous layer (690);
v. separating (650) the organic layer (670) of a nickel-solvent complex and treating (700) by using a third acidic solution (760) to obtain a second biphasic mixture comprising a nickel-containing aqueous phase and the organic solvent phase (790);
vi. separating (750) nickel-containing aqueous phase from the second biphasic mixture to obtain a separated nickel-containing aqueous phase (770);
vii. treating (800) the second leachate solution (470) obtained in step (ii) and the separated nickel-containing aqueous phase (770) obtained in step (vi) by using an alkali hydroxide (860) under continuous stirring to obtain a slurry comprising a precipitate of nickel hydroxide (870) and an aqueous solution (890);
viii. separating (850) the nickel hydroxide precipitate (870) followed by drying (900) and calcinating (950) at a third predetermined temperature for a third predetermined time period to obtain nickel (970) in the form of nickel oxide The present disclosure provides the process (1000) of extracting nickel from the gasifier slag (10). The process (1000) integrates the process of salt roasting (100) with water leaching (200) for nickel enrichment followed by solvent leaching (300/500), nickel precipitation and purification with selective chemicals.

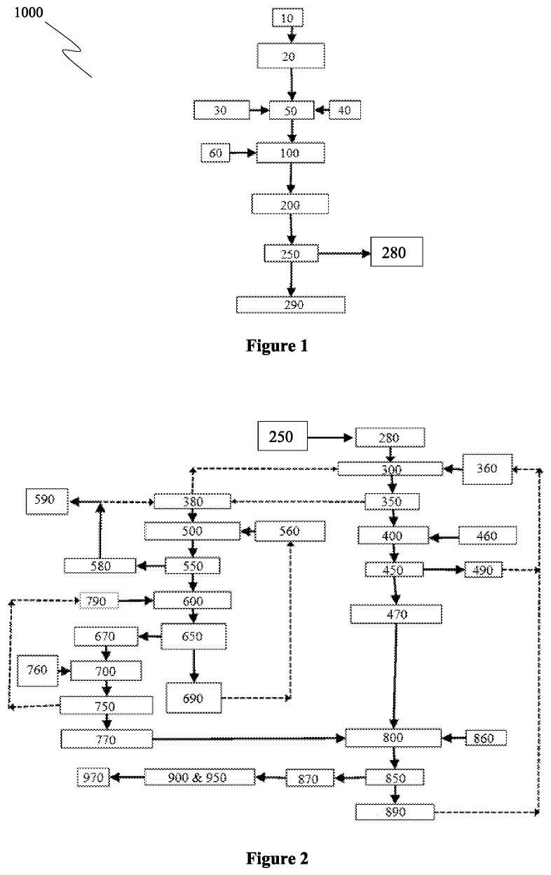

The process (1000) will now be described in detail with reference to FIG. 1 through FIG. 3. The present embodiment does not limit the scope and ambit of the present disclosure.

FIG. 1 of the present disclosure discloses the typical process of salt roasting of the gasifier slag with the alkali salt to increase the oxidation state of nickel followed by water leaching.

The gasifier slag has a complex structure. In the gasifier slag feed, nickel is trapped within a spinel structure along with other metals such as silica, aluminum, calcium, and others, making it challenging to extract the nickel with maximum recovery and high purity.

Therefore, prior to the nickel extraction process from the gasifier slag, the gasifier slag undergoes a salt roasting and a water leaching process to remove undesirable metal components and impurities, and to optimize the yield and purity of the nickel.

The salt roasting is to be done in the presence of excess air at a temperature above the decomposition temperature of the alkali salt to facilitate the availability of more alkali oxide (e.g., Na₂O) for increasing the oxidation state of all metals. The metals present in the gasifier slag such as vanadium, sodium, molybdenite, and chromium, after salt roasting step are converted into the alkali meta vanadate, alkali meta chromate, alkali molybdenite which are water soluble and easily separated from the gasifier slag.

As depicted in FIG. 1, the gasifier slag (10) is finely grounded (20) to have a particle size of less than 75 μm. The crushed gasifier slag has a sufficient surface area for better dispersion of alkali salt. The crushed gasifier slag is soaked (50) with the alkali salts (30) in water (40) for a time period in the range of 4 hours to 6 hours to obtain a salt-soaked slag, and subsequently dried. The dried salt-soaked slag is further mixed by grinding thoroughly to ensure the homogeneity of samples for the availability of the alkali salt for the process of salt roasting.

The salt roasting (100) of the dried salt-soaked slag with alkali salt is carried out at a temperature in the range of 800° C. to 1100° C. for a time period in the range of 1 hour to 5 hours in the presence of air (60) to obtain a roasted slag. Further, the roasted slag is subjected to the water-leaching (200) process. The water for the water leaching process is heated at a temperature in the range of 60° C. to 120° C. for a time period in the range of 1 hour to 4 hours, followed by filtering (250) to obtain the solid phase containing nickel and solution (290) containing alkali metal salts of vanadium, sodium, molybdenite, chromium and the like.

In an embodiment, the alkali salt (30) is at least one selected from the group consisting of sodium carbonate (Na₂CO₃), sodium hydroxide (NaOH) and sodium sulfate (Na₂SO₄).

After the solution (290) containing alkali metal salts is separated, the solid phase containing nickel is further pulverized to reduce the particle size. The resulting product is a pulverized gasifier slag (280) that is enriched with nickel. This pulverized gasifier slag (280) is used as a feed and undergoes the nickel extraction process in accordance with the present disclosure.

In an embodiment, the pulverized gasifier slag (280) has a particle size of less than 45 μm.

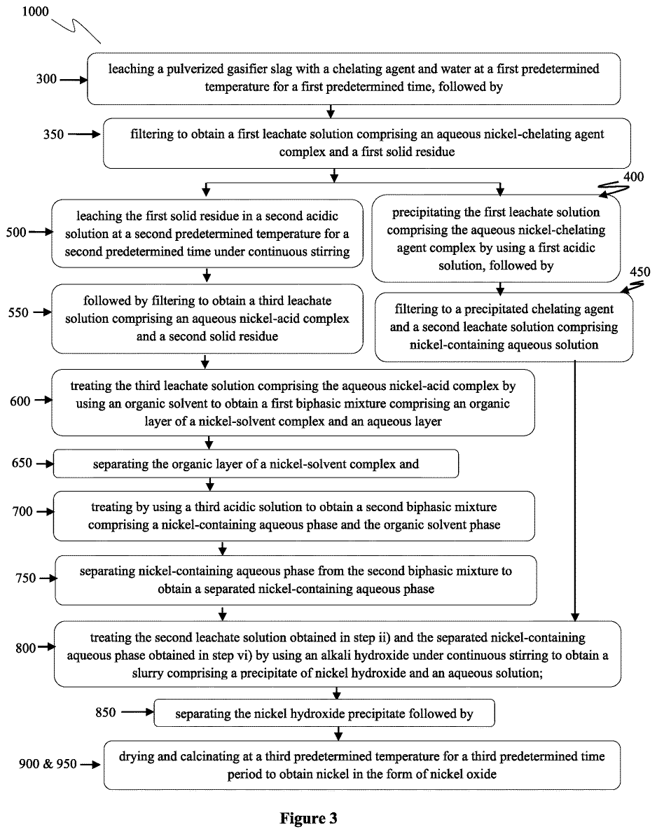

FIG. 2 and FIG. 3 of the present disclosure illustrate the process of extracting nickel from the pulverized gasifier slag (280). The process steps of extraction of nickel from the pulverized gasifier slag (280) are provided herein below in detail:

In the first step (300), the pulverized gasifier slag (280) undergoes the leaching process with a chelating agent (360) at a first predetermined temperature for a first predetermined time, followed by filtering (350) to obtain a first leachate solution comprising an aqueous nickel-chelating agent complex and a first solid residue (380).

The nickel extraction process uses a two-stage leaching to attain maximum nickel recovery with high purity. In the first stage of leaching, a mild solvent is used to react with the pulverized gasifier slag (280). A mild solvent such as a chelating agent is used for the first stage of leaching to extract nickel from the pulverized gasifier slag (280).

In an embodiment, the chelating agent (360) is selected from the group consisting of Ethylenediaminetetraacetic acid (EDTA), Dimethylglyoxime (DMG), and diethylenetriamine penta acetic acid (DTPA).

In an embodiment, the first predetermined temperature is in the range of 60° C. to 160° C. and the first predetermined time period is in the range of 2 hours to 8 hours. In an exemplary embodiment, the first predetermined temperature is 140° C. and the first predetermined time period is 6 hours.

In an embodiment, the leaching of the pulverized gasifier slag (280) in the chelating agent (360) is carried out by maintaining pH in the range of 8 to 10.

In an embodiment, a weight ratio of the pulverized gasifier slag to the chelating agent (360) is in the range of 1:1 to 5:1. In an exemplary embodiment, the weight ratio of the pulverized gasifier slag to the chelating agent (360) is 3:1.

In an embodiment, a weight ratio of the pulverized gasifier slag (280) to water in the step (i) is in the range of 1:2 to 1:5. In an exemplary embodiment, the weight ratio of the pulverized gasifier slag (280) to water in the step (i) is 1:3.

In an exemplary embodiment, the finely grounded feed of the pulverized gasifier slag (280) is poured into the Ethylenediaminetetraacetic acid (EDTA) aqueous solution and agitated at 400 rpm. Leaching of the pulverized gasifier slag is continued for a few hours at a temperature in the range of 60° C. to 160° C., preferably at a temperature of 90° C. in a closed loop water condensing system. The leaching step is followed by filtering to obtain the first leachate solution comprising an aqueous nickel-chelating agent complex and a first solid residue (380).

In the second step (400), the first leachate solution comprising the aqueous nickel-chelating agent complex is precipitated by using a first acidic solution (460), followed by filtering (450) to obtain a precipitated chelating agent (490) and a second leachate solution (470) comprising a nickel-containing aqueous solution In an embodiment, the precipitated chelating agent (490) is recovered by maintaining the pH of the first leachate solution containing nickel-chelating agent complex in the range of 1 to 5; wherein the pH is maintained by using the first acidic solution (460).

In an exemplary embodiment, after the first solid residue (380) is separated in the first step by filtering out from the first leachate solution, the first leachate solution comprising an aqueous nickel-chelating agent complex undergoes the precipitation step (400) by using the first acidic solution (460). The first acidic solution (460) is added to decrease the pH of the solution to 2. The precipitation step is followed by filtration to obtain a precipitated chelating agent (490) and a second leachate solution (470) comprising a nickel-containing aqueous solution.

In the third step (500), the first solid residue (380) undergoes the leaching (500) process with a second acidic solution (560) at a second predetermined temperature for a second predetermined time under continuous stirring followed by filtering (550) to obtain a third leachate solution comprising an aqueous nickel-acid complex and a second solid residue (580).

In an embodiment, the second predetermined temperature is in the range of 40° C. to 140° C. and the second predetermined time period is in the range of 2 hours to 6 hours. In an exemplary embodiment, the second predetermined temperature is 120° C. and the second predetermined time period is 6 hours.

The leaching process carried out by using the second acidic solution (560) is a second stage of leaching. The first solid residue (380) separated in the first steps undergoes the second stage of leaching by using the second acidic solution (560) under continuous mixing conditions. The leaching process is followed by filtering to obtain the third leachate solution comprising an aqueous nickel-acid complex and a second solid residue (580).

In an embodiment, a weight ratio of the first solid residue to the second acidic solution in step (iii) is in the range of 1:2 to 1:5. In an exemplary embodiment, the weight ratio of the first solid residue to the second acidic solution in step (iii) is 1:4 In an embodiment, the amount of the second acid is in the range of 20 wt % to 60 wt % with respect to the total weight of the second acidic solution. In an exemplary embodiment, the amount of the second acid is 50 wt % with respect to the total weight of the second acidic solution In an embodiment, the first acidic solution (460) and the second acidic solution (560) are independently selected from nitric acid (HNO₃), sulphuric acid (H₂SO₄) and mixtures thereof.

In an exemplary embodiment, the second stage of leaching is carried out with HNO₃ or H₂SO₄ at a temperature of 120° C. for 6 hours of residence time to obtain the third leachate solution. Further, the third leachate solution containing nickel-acid complex is separated from the remaining solid material i.e. second solid residue (580) by filtration (550). As the nickel oxidation state increases by salt roasting, the acid consumption for leaching and extraction of undesirable metals will be minimized and therefore, selective refining of nickel from the third leachate solution should be carried out with a specific organic solvent. The second solid residue (580) is stored as a purge solid (590). The second solid residue (590) is analyzed for the nickel content and if a recoverable amount of nickel is present in the second solid residue (580), it is recycled for acidic leaching (500) to further extract nickel from the second solid residue (580), otherwise, stored as purge solid (590) and removed for further processing.

In the fourth step (600), the third leachate solution comprising the aqueous nickel-acid complex is treated by using an organic solvent (790) to obtain a first biphasic mixture comprising an organic layer of a nickel-solvent complex (670) and an aqueous layer (690) In the third step, after completion of the second stage of leaching, the second solid residue (580) and the third leachate solution are obtained. The second solid residue is separated as a purged solid (590) and the third leachate solution is further processed in the fourth step to treat with the organic solvent.

In an embodiment, the organic solvent (790) is used as an extraction agent for extracting nickel from the third leachate solution comprising the aqueous nickel-acid complex, wherein the organic solvent (790) is selected from 2-hydroxy-5-nonylaceto-phenone oxime (LIX-84i), 1-phenyl-3-hydroxy-4-oxime-5-pyrazolone (LIX622), 1-phenyl-3,5-dimethyl-4-oxime-5-pyrazolone (LIX 860) and 1-phenyl-3-methyl-4-oxime-5-pyrazolone (LIX 984 NC).

In an exemplary embodiment, the organic solvent (790) used to extract nickel from the third leachate solution comprising the aqueous nickel-acid complex is 2-hydroxy-5-nonylaceto-phenone oxime (LIX-84i) Nickel precipitation from the third leachate solution is carried out by using a known quantity of LIX-84i dissolved in kerosene, wherein the nickel LIX-84i complex is formed as an organic phase. The treatment of the third leachate solution produces the biphasic mixture.

This biphasic mixture is separated by decantation to obtain the organic layer of a nickel-solvent complex (670) and an aqueous layer (690). The aqueous layer (690) is nickel deficient, which is recycled to the third step for acid leaching (500).

In the fifth step (650), the organic layer (670) containing a nickel-solvent complex is separated and treated (700) by using the third acidic solution (760) to obtain a second biphasic mixture comprising a nickel-containing aqueous phase and the organic solvent phase (790).

In an embodiment, the third acidic solution is independently selected from nitric acid (HNO₃) and sulphuric acid (H₂SO₄) and mixtures thereof.

In an embodiment, the nickel is recovered from the nickel-solvent complex by lowering the pH of the nickel-solvent complex in the range of 1 to 5 by using the third acidic solution.

In an exemplary embodiment, the separated organic layer (670) containing a nickel-solvent complex (Ni-LIX) is treated with H₂SO₄/HNO₃ to maintain the pH of the solution to 1 and thereafter separation of LIX organic phase by decantation to reuse in the fourth step for the extraction of nickel from the first solid residue (380), whereas the second biphasic mixture comprising a nickel-containing aqueous phase is further processed for extraction of nickel.

In the sixth step (800), the nickel-containing aqueous phase is separated from the second biphasic mixture to obtain a separated nickel-containing aqueous phase (770). The filtration or the decantation process is used for separating the organic solvent phase from the second biphasic mixture and to obtain the desired aqueous phase containing the nickel.

In the seventh step (800), the second leachate solution (470) obtained in the second step and the separated nickel-containing aqueous phase (770) obtained in the sixth step is treated by using an alkali hydroxide (860) under continuous stirring to obtain a slurry comprising a precipitate of nickel hydroxide (870) and an aqueous solution (890).

The nickel-containing solutions obtained after the two stages of leaching i.e., the second leachate solution (470) obtained after the first stage of leaching carried out by using the mild chelating agent (360) and the separated nickel-containing aqueous phase (770) obtained after the second stage of leaching carried out by using the acidic solution (560) are subjected to the precipitation process (800) in the seventh step by using the alkali hydroxide (860) to obtain the slurry comprising the precipitate of nickel hydroxide.

In an embodiment, the precipitation (800) of nickel from the nickel-containing solutions is carried out by maintaining pH in the range of 8 to 12 to obtain the slurry comprising the precipitate of nickel hydroxide (Ni (OH)₂).

In an embodiment, the alkali hydroxide (860) is at least one selected from the group consisting of sodium hydroxide (NaOH), Magnesium hydroxide (Mg(OH)₂), and potassium hydroxide (KOH).

In an exemplary embodiment, the alkali hydroxide (860) used for the precipitation process is sodium hydroxide (NaOH).

In an exemplary embodiment, nickel-containing solutions (470 & 770) are treated with 2 wt % of sodium hydroxide (NaOH) under continuous stirring conditions to obtain precipitated nickel as nickel hydroxide (Ni(OH)₂) and subsequently separating the nickel hydroxide via filtration (850).

In the eighth step (850), the nickel hydroxide precipitate (870) is separated from the aqueous solution, followed by drying (900) and calcinating (950) at a third predetermined temperature for a third predetermined time period to obtain nickel (970) in the form of nickel oxide (NiO).

In an embodiment, the third predetermined temperature is in the range of 100° C. to 300° C. and the third predetermined time period is in the range of 1 hour to 5 hours. In an exemplary embodiment, the third predetermined temperature is 120° C. and the third predetermined time is 2 hours.

In an exemplary embodiment, the separated nickel hydroxide (Ni (OH)₂) is dried by heating in a muffle furnace at a required temperature of 250° C. for a time period of 2 hours. After completion of the drying step, the dried nickel precipitate is calcinated to obtain nickel in the form of nickel oxide.

In an embodiment, the first solid residue (380) and the second solid residue (580) contain silica, alumina, calcium, iron and magnesium.

The process (1000) minimizes the consumption of chemicals and additives used in the leaching, precipitation and purification steps, through efficient process intensification and the recycling of all intermediate streams containing agents, making the process more sustainable and cost-effective.

In an embodiment, the precipitated chelating agent (490) obtained in the second step is recycled to the first step for extracting nickel from the pulverized gasifier slag (280).

In an embodiment, the aqueous layer (690) obtained in the fourth step is recycled to the third step for extracting nickel from the first solid residue (380).

In an embodiment, the organic solvent phase (790) obtained in the fifth step is recycled to the fourth step for treating (600) the third leachate solution comprising the aqueous nickel-acid complex.

In an embodiment, the aqueous solution (890) obtained in the seventh step is recycled to the first step for extracting nickel from the pulverized gasifier slag (280).

The recycling of the intermediate stream containing agents minimizes the consumption of chemicals and additives, which is commercially viable and reduces the operating cost.

In an embodiment, the process (1000) is a continuous process of extracting the nickel in the oxide form from the pulverized gasifier slag (280).

In an embodiment, the extracted nickel has a recovery rate in the range of 15% to 80% and purity in the range of 50% to 99%.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to an industrial/commercial scale and the results obtained can be extrapolated to an industrial scale.

### EXPERIMENTAL DETAILS

### Experiment 1: A Process for Obtaining the Pulverized Gasifier Slag (280) (by Conventional Method)

A 100 gm of gasifier slag having a particle size less than 75 μm was soaked with 50 gm of Na₂CO₃, 50 gms of NaOH, and dried at 150° C. to obtain salt-soaked slag. The salt-soaked slag was roasted at 950° C. for 3 hours to obtain a roasted slag. The roasted slag was leached in water at 90° C., for 3 hours with water to the roasted slag ratio of 3:1 to obtain a slurry. The slurry was filtered to obtain a residue (gasifier slag) and a filtrate solution containing Na, V, Mo and Cr. The composition of the gasifier slag was analyzed and provided in Table 1 which is considered as feed for extracting nickel. The gasifier slag was finely ground and screened to reduce its particle size to less than 45 μm. This processed sample (referred to as pulverized gasifier slag) was then used for nickel extraction in the process of the present disclosure.

TABLE 1
Composition of Petcoke-fired gasifier slag

| Metals | Feed Slag | 1^{st} Residue after water leaching |
|---|---|---|
| Na₂O | 1.01 | 15.44 |
| MgO | 2.38 | 0.63 |
| Al₂O₃ | 17.28 | 20.18 |
| SiO₂ | 32.11 | 28.86 |
| P₂O₅ | 0.39 | 0.52 |
| SO₃ | 2.66 | 2.24 |
| K₂O | 0.56 | 0.11 |
| CaO | 23.91 | 20.66 |
| TiO₂ | 1.01 | 0.8 |
| V₂O₅ | 6.62 | 2.07 |
| Cr₂O₃ | 0.14 | 0.22 |
| MnO | 0.13 | 0.09 |
| Fe₂O₃ | 9.24 | 5.58 |
| NiO | 2.23 | 2.22 |
| CuO | 0.01 | 0.05 |
| ZrO₂ | 0.02 | 0.04 |
| SrO | 0.2 | 0.2 |
| BaO | 0.1 | 0.1 |

Experiment 2: a process for extracting nickel from the pulverized gasifier slag using EDTA as a leaching agent. The pulverized gasifier slag was obtained from Experiment 1.

A 100 gm of pulverized gasifier slag (post vanadium extracted residue) having a particle size of less than 45 μm was leached in 400 ml of 50 wt. % of aqueous EDTA (chelating agent) at 140° C., for 6 hours, and filtered to obtain a first leachate solution comprising an aqueous nickel-EDTA complex and a first solid residue (380). The water to pulverized gasifier slag ratio was taken as 3:1 for making the EDTA solution for leaching.

The first leachate solution comprising the aqueous nickel-EDTA complex was treated by using 50 ml of conc. HNO₃ to arrive at a pH of 2 (to precipitate EDTA) and filtered to obtain a precipitated EDTA and a second leachate solution comprising a nickel-containing aqueous solution.

The second leachate solution comprising a nickel-containing aqueous solution was treated by using NaOH (2 wt. % of feed) to arrive at a pH of the solution to 8 under continuous stirring at 400 rpm to obtain a slurry comprising a precipitate of nickel hydroxide (Ni(OH)₂) and an aqueous solution. The nickel hydroxide precipitate (Ni(OH)₂) was separated. The separated (Ni(OH)₂) was dried at 120° C. and calcinated at 250° C. for 4 hours to obtain nickel (Ni) in the form of nickel oxide (NiO).

XRF analysis for all samples was carried out to estimate the nickel recovery and obtained the Nickel recovery of 33% with a purity of 58.9%.

Example 1 to Example 5 demonstrates the various results of nickel recovery rate with purity by varying the process parameters (temperature, time, concentration, wt. % and the like) and using the first stage of leaching only. Example 6 demonstrates the first stage and second stage of leaching.

Example 1 (1^{st} stage of leaching using EDTA) Example 1 was carried out using a similar procedure as provided in Experiment 2, except by varying the concentration of EDTA to 20 wt. % of pulverized gasifier slag to obtain Nickel in the form of nickel oxide (NiO).

XRF analysis for all samples was carried out to estimate the nickel recovery, and the obtained Nickel recovery was 42% with a purity of 58.5%

### Example 2 (1^{st} Stage of Leaching Using EDTA)

Example 2 was carried out using a similar procedure as provided in Experiment 2, except by using 30 wt. % of EDTA and keeping all other parameters the same, to obtain Nickel in the form of nickel oxide (NiO).

XRF analysis for all samples was carried out to estimate the nickel recovery, and the obtained nickel recovery was 51% with purity of 58.6%.

### Example 3 (1^{st} Stage of Leaching Using EDTA)

Example 3 was carried out by using a similar procedure as provided in Example 1, except by varying the water-to-pulverized gasifier slag ratio to 1:1 for making EDTA solution to obtain Nickel in the form of nickel oxide (NiO).

XRF analysis for all samples was carried out to estimate the nickel recovery, and the obtained Nickel recovery was 39% with a purity of 96.8% Example 4 (1^{st} stage of leaching using EDTA) Example 4 was carried out by using a similar procedure as provided in Example 1 except by varying the leaching time to 2 hours to obtain Nickel in the form of nickel oxide (NiO).

XRF analysis for all samples was carried out to estimate the nickel recovery and the obtained Nickel recovery was 36% with a purity of 98.4%

### Example 5 (1^{st} Stage of Leaching Using EDTA)

Example 5 was carried out by using a similar procedure as provided in Example 1 except by varying the leaching temperature to 80° C. to obtain Nickel in the form of nickel oxide (NiO).

XRF analysis for all samples was carried out to estimate the nickel recovery, and the obtained Nickel recovery was 35% with a purity of 98.9% Example 6 (1^{st} and 2^{nd} stage of leaching using EDTA) Example 6 was carried out by using a similar procedure as provided in Example 2 for the first stage of leaching of the pulverized gasifier slag using 30 wt. % of EDTA, and the nickel recovery was 51% with purity of 58.6%. A 1^{st} solid residue was obtained after completion of the first stage of leaching, this 1^{st} solid residue was further processed for the 2^{nd} stage of leaching using 30 wt. % of EDTA (as disclosed in Experiment 2) to obtain Nickel in the form of nickel oxide (NiO).

It was observed that 32% of nickel was recovered from the 1^{st} solid residue after completion of the 2^{nd} stage of leaching. The overall Nickel recovery from the combined two-stage of leaching was 66.7%

Experiment 3: a process for extracting nickel from the pulverized gasifier slag using an acidic solution (H₂SO₄) as a leaching agent. The pulverized gasifier slag was obtained from Experiment 1.

Experiment 3 was carried out using the 1^{st} stage of leaching and using 50 wt. % of H₂SO₄. The water to pulverized gasifier slag weight ratio was taken as 3:1 for making an acid solution for leaching. 100 gm of pulverized gasifier slag was leached in 300 ml of 50 wt. % of H₂SO₄, at 120° C. for 6 hours, under continuous stirring at 400 rpm followed by cooling to RT and filtered to obtain a third leachate solution comprising an aqueous nickel-acid complex and a second solid residue. The third leachate solution comprising the aqueous nickel-acid complex was treated with LIX84i (3 wt. % of feed) to obtain a first biphasic mixture comprising an organic layer of a nickel-LIX phase and an aqueous layer (690).

The organic layer of a nickel-LIX was separated by decantation and treated (700) by using 5 ml to 10 ml of H₂SO₄ by adjusting at a pH of 1 to obtain a second biphasic mixture comprising a nickel-containing aqueous phase and the organic solvent phase (LIX-84i).

Nickel-containing aqueous phase was separated from the second biphasic mixture to obtain a separated nickel-containing aqueous phase.

The separated nickel-containing aqueous phase was treated by NaOH (2 wt. % of feed) to arrive at a pH of the solution to 8 under continuous stirring at 400 rpm to obtain a slurry comprising a precipitate of nickel hydroxide (Ni(OH)₂) and an aqueous solution. The nickel hydroxide precipitate (Ni(OH)₂) was separated. The separated (Ni(OH)₂) was dried at 120° C. and calcinated at 250° C. for 4 hours to obtain nickel (Ni) in the form of nickel oxide (NiO).

XRF analysis for all samples was carried out to estimate the nickel recovery and the obtained nickel recovery was 49% with a purity of 62.7% Examples 7 to Example 11 show the results of nickel recovery and purity with varying process parameters (such as acidic solution, temperature, time, concentration, and wt. %) using an acidic solution (H₂SO₄/HNO₃) as the leaching agent in the first stage of leaching.

Example 12 illustrates both the first and second stages of leaching using an acidic solution (H₂SO₄).

### Example 7 (1^{st} Stage of Leaching Using Acidic Solution (HNO₃))

Example 7 was carried out with 100 gm of pulverized gasifier slag leached in concentrated HNO₃ (whose weight is equal to 50 wt % of feed) at 120° C. for 6 hours under continuous stirring at 400 rpm followed by cooling to RT and filtered to obtain a third leachate solution comprising an aqueous nickel-acid complex and a second solid residue. The third leachate solution comprising the aqueous nickel-acid complex was treated with LIX84i (3 wt. % of the feed) (organic solvent) to obtain a first biphasic mixture comprising an organic layer of a nickel-LIX phase and an aqueous layer (690).

The organic layer of a nickel-LIX was separated by decantation and treated by using 5 ml-10 ml of conc. HNO₃ by adjusting at a pH of 1 to obtain a second biphasic mixture comprising a nickel-containing aqueous phase and the organic solvent phase (LIX-84i).

Nickel-containing aqueous phase was separated from the second biphasic mixture to obtain a separated nickel-containing aqueous phase.

The separated nickel-containing aqueous phase was treated by using NaOH (2 wt. % of feed) to arrive at a pH of the solution to 8 under continuous stirring at 400 rpm to obtain a slurry comprising a precipitate of nickel hydroxide (Ni(OH)₂) and an aqueous solution. The nickel hydroxide precipitate (Ni(OH)₂) was separated. The separated (Ni(OH)₂) was dried at 120° C. and calcinated at 250° C. for 4 hours to obtain nickel (Ni) in the form of nickel oxide (NiO).

XRF analysis for all samples has been carried out to estimate the nickel recovery and the obtained nickel recovery was 48% with a purity of 61.3% Example 8 (1^{st} stage of leaching using acidic solution (H₂SO₄)) Example 8 was carried out in a similar manner to Experiment 3, except by varying the concentration of H₂SO₄ to 20 wt. % of feed to obtain Nickel in the form of nickel oxide (NiO), to obtain Nickel in the form of nickel oxide (NiO).

XRF analysis for all samples was carried out to estimate the nickel recovery and the obtained Nickel recovery was 22% with a purity of 92.9%.

### Example 9 (1^{st} Stage of Leaching Using Acidic Solution (H₂SO₄))

Example 9 was carried out in a similar manner to Experiment 3, except by varying a water-to-pulverized gasifier slag weight ratio to 1:1 for making the acid solution for leaching to obtain Nickel in the form of nickel oxide (NiO).

XRF analysis for all samples was carried out to estimate the nickel recovery and the obtained Nickel recovery was 64% with a purity of 61.8%

### Example 10 (1^{st} Stage of Leaching Using Acidic Solution (H₂SO₄))

Example 10 was carried out in a similar manner to Experiment 3, except by varying the leaching time to 2 hours to obtain Nickel in the form of nickel oxide (NiO).

XRF analysis for all samples was carried out to estimate the nickel recovery and the obtained Nickel recovery was 31% with a purity of 92.4%

### Example 11 (1^{st} Stage of Leaching Using Acidic Solution (H₂SO₄))

Example 10 was carried out in a similar manner to Experiment 3, except by varying the leaching temperature to 80° C. to obtain Nickel in the form of nickel oxide (NiO).

XRF analysis for all samples was carried out to estimate the nickel recovery and the obtained nickel recovery was 32% with a purity of 52.1%

### Example 12 (1^{st} and 2^{nd} Stage of Leaching Using Acidic Solution (H₂SO₄))

Example 12 was carried out in a similar manner to Experiment 3. In Experiment 3, nickel recovery was 49% obtained from the pulverized gasifier slag. The 1^{st} residue obtained from the 1^{st} stage of leaching was further leached (2^{nd} stage of leaching) in a similar manner to Experiment 3 under the same conditions for the 2^{nd} time to extract the nickel.

It was observed that 34% of nickel was recovered from the 1^{st} solid residue after completion of the 2^{nd} stage of leaching. The overall Nickel recovery from the combined two-stage leaching was 68.3% with a purity of 62.7% Experiment 4: a process for extracting nickel from the pulverized gasifier slag using two stages of leaching, in the first stage of leaching EDTA was used and in the second stage of leaching H₂SO₄ was used in accordance with the present disclosure.

A 100 gm of pulverized gasifier slag (post vanadium extracted residue) having a particle size of less than 45 μm was leached (first stage of leaching) in aqueous EDTA (chelating agent) (30 wt. % of feed) at 140° C., for 6 hours, and filtered to obtain a first leachate solution comprising an aqueous nickel-EDTA complex and a first solid residue (380). The water to pulverized gasifier slag ratio was taken as 3:1 for making the EDTA solution for leaching.

The first leachate solution comprising the aqueous nickel-EDTA complex was treated by using 40 ml to 60 ml of conc. HNO₃ to arrive at a pH of 2 (to precipitate EDTA) and filtered to obtain a precipitated EDTA and a second leachate solution comprising a nickel-containing aqueous solution.

The first solid residue was leached (second stage of leaching) by using 50 wt. % of H₂SO₄ (Solid to Liquid ratio: 3) and heated to 120° C. for 6 hours under continuous stirring at 400 rpm followed by cooling to RT and filtered to obtain a third leachate solution comprising an aqueous nickel-acid complex and a second solid residue. The third leachate solution comprising the aqueous nickel-acid complex was treated with LIX-841 (organic solvent) (3 wt. % of feed) to obtain a first biphasic mixture comprising an organic layer of a nickel-LIX phase and an aqueous layer (690).

The organic layer of a nickel-LIX was separated by decantation and treated (700) by using 5 ml to 10 ml of H₂SO₄ by adjusting at a pH of 1 to obtain a second biphasic mixture comprising a nickel-containing aqueous phase and the organic solvent phase (LIX-84i).

Nickel-containing aqueous phase was separated from the second biphasic mixture to obtain a separated nickel-containing aqueous phase.

The second leachate solution (obtained after 1st stage of leaching) and the separated nickel-containing aqueous phase (obtained after 2^{nd} stage of leaching) were treated by using NaOH (alkali hydroxide) (2 wt. % of feed) to arrive at a pH of the solution to 8 under continuous stirring at 400 rpm to obtain a slurry comprising a precipitate of nickel hydroxide (Ni(OH)₂) and an aqueous solution. The nickel hydroxide precipitate (Ni(OH)₂) was separated. The separated (Ni(OH)₂) was dried at 120° C. and calcinated at 250° C. for 4 hours to obtain nickel (Ni) in the form of nickel oxide (NiO).

After combining the first stage of the leaching process (by using 30 wt. % of EDTA) and the second stage of the leaching process (by using 50 wt. % of H₂SO₄) in accordance with the present disclosure, XRF analysis for all samples was carried out to estimate the nickel recovery. The overall nickel recovery rate was 80.1% with a purity of 62.3%.

### Example 13 (comparative Example)

In Example 13, pulverized gasification slag of particle size less than 45 microns was considered for the extraction of nickel with EDTA in a similar manner to Example 2. It was observed that 19% of nickel recovered with a purity of 85% from the gasification slag with the 1^{st} stage of leaching with EDTA under similar conditions to that of Example 2. However, the pulverized gasification slag used in the present example (Example 13) did not undergo the salt roasting process as provided in Experiment 1, and the nickel was embedded with other metals in the reduced oxidation state of spinel structure, which leads to poor recovery.

### Example 14 (Comparative Example)

In Example 13, pulverized gasification slag of particle size less than 45 microns was considered for the extraction of nickel, wherein H₂SO₄ was used as a solvent and the process was carried out under similar conditions to Experiment 3.

It was observed that 25% of nickel recovered with a purity of 81% from the gasification slag with the 1^{st} stage of leaching with H₂SO₄ under similar conditions to that of Experiment 3. However, the pulverized gasification slag used in the present example (Example 14) did not undergo the salt roasting process as provided in Experiment 1, hence the recovery rate was poor i.e. only 25% nickel was recovered.

Table 2 represents the summarized version of the experimental details provided herein above. Experiment 1 was related to the salt roasting process; Experiment 2 was related to the leaching process carried out by using EDTA; Experiment 3 was related to the leaching process carried out by using an acidic solution (H₂SO₄); and Experiment 4 was related to two-stage leaching process carried out by using EDTA (1^{st} stage) and an acidic solution H₂SO₄ (2^{nd} stage).

TABLE 2

| | | | | | | Water | | |
|---|---|---|---|---|---|---|---|---|
| | | | | Pre. | Pre. | to | Recovery | |
| Exp. | | | | Temp. | Time | Feed | rate | Purity |
| No | Feed | process | Solvent | (° C.) | (Hour) | ratio | (%) | (%) |
| Exp. 1 | 100 gm | salt | With | Salt soaking Followed by salt roasting of salt | | | | |
| | of slag | soaking | Na₂CO₃ | soaked slag at 950° C. for 3 hrs. to get | | | | |
| | having | on feed | and | roasted cinder | | | | |
| | 75 μ | slag | NaOH | | | | | |
| | size | | | | | | | |
| | Roasted | leaching | With | 90 | 3 | 4 | To get solid | |
| | cinder | | water | | | | residue enriched | |
| | | | | | | | with nickel | |
| Exp. 2 | Solid | The first | 50 wt. | 140 | 6 | 3:1 | 33 | 58.9 |
| | residue | stage of | % | | | | | |
| | enriched | leaching | EDTA | | | | | |
| | with | | | | | | | |
| | nickel | | | | | | | |
| | Pulverized | | | | | | | |
| | gasifier | | | | | | | |
| | slag | | | | | | | |
| | (PGS) | | | | | | | |
| | obtained | | | | | | | |
| | from | | | | | | | |
| | Exp. 1 | | | | | | | |
| Ex. 1 | PGS | First | 20 wt. | 140 | 6 | 3:1 | 42 | 58.5 |
| | | stage of | % | | | | | |
| | | leaching | EDTA | | | | | |
| Ex. 2 | PGS | First | 30 wt. | 140 | 6 | 3:1 | 51 | 58.6 |
| | | stage of | % | | | | | |
| | | leaching | EDTA | | | | | |
| Ex. 3 | PGS | First | 20 wt. | 140 | 6 | 1:1 | 39 | 96.8 |
| | | stage of | % | | | | | |
| | | leaching | EDTA | | | | | |
| Ex. 4 | PGS | First | 20 wt. | 140 | 2 | 3:1 | 36 | 98.4 |
| | | stage of | % | | | | | |
| | | leaching | EDTA | | | | | |
| Ex. 5 | PGS | First | 20 wt. | 80 | 6 | 3:1 | 35 | 98.9 |
| | | stage of | % | | | | | |
| | | leaching | EDTA | | | | | |
| Ex. 6 | PGS | First | 30 wt. | 140 | 6 | 3:1 | 66.7 | 58.6 |
| | and 1^{st} | stage of | % | | | | | |
| | solid | leaching, | EDTA | | | | | |
| | residue | followed | | | | | | |
| | | by 2^{nd} | | | | | | |
| | | stage of | | | | | | |
| | | leaching | | | | | | |
| Exp. 3 | PGS | First | 50 wt. | 120 | 6 | 3:1 | 49 | 62.7 |
| | | stage of | % | | | | | |
| | | leaching, | H₂SO₄ | | | | | |
| | | followed | | | | | | |
| | | by | | | | | | |
| | | refining | | | | | | |
| | | with LIX- | | | | | | |
| | | 84I | | | | | | |
| Ex. 7 | PGS | First | 50 wt. | 120 | 6 | 3:1 | 48 | 61.3 |
| | | stage of | % | | | | | |
| | | leaching, | HNO₃ | | | | | |
| | | followed | | | | | | |
| | | by nickel | | | | | | |
| | | refining | | | | | | |
| | | with LIX- | | | | | | |
| | | 84I | | | | | | |
| Ex. 8 | PGS | First | 20 wt. | 120 | 6 | 3:1 | 22 | 92.9 |
| | | stage of | % | | | | | |
| | | leaching, | H₂SO₄ | | | | | |
| | | followed | | | | | | |
| | | by nickel | | | | | | |
| | | refining | | | | | | |
| | | with LIX- | | | | | | |
| | | 84I | | | | | | |
| Ex. 9 | PGS | First | 50 wt. | 120 | 6 | 1:1 | 64 | 61.8 |
| | | stage of | % | | | | | |
| | | leaching | H₂SO₄ | | | | | |
| | | followed | | | | | | |
| | | by | | | | | | |
| | | refining | | | | | | |
| | | with LIX- | | | | | | |
| | | 84I | | | | | | |
| Ex. 10 | PGS | First | 50 wt. | 120 | 2 | 3:1 | 31 | 92.4 |
| | | stage of | % | | | | | |
| | | leaching | H₂SO₄ | | | | | |
| | | followed | | | | | | |
| | | by | | | | | | |
| | | refining | | | | | | |
| | | with LIX- | | | | | | |
| | | 84I | | | | | | |
| Ex. 11 | PGS | First | 50 wt. | 80 | 6 | 3:1 | 32 | 52.1 |
| | | stage of | % | | | | | |
| | | leaching | H₂SO₄ | | | | | |
| | | followed | | | | | | |
| | | by | | | | | | |
| | | refining | | | | | | |
| | | with LIX- | | | | | | |
| | | 84I | | | | | | |
| Ex. 12 | PGS | First | 50 wt. | 120 | 6 | 3:1 | 68.3 | 62.7 |
| | and 1^{st} | stage of | % | | | | | |
| | solid | leaching, | H₂SO₄ | | | | | |
| | residue | and 2^{nd} | | | | | | |
| | | stage of | | | | | | |
| | | leaching | | | | | | |
| | | along | | | | | | |
| | | with | | | | | | |
| | | nickel | | | | | | |
| | | refining | | | | | | |
| | | using | | | | | | |
| | | LIX-84I | | | | | | |
| Exp. 4 | PGS | First | 30 wt. | 140 | 6 | 3:1 | 51 | 58.6 |
| | and 1st | stage | % | | | | | |
| | solid | leaching | EDTA | | | | | |
| | residue | Second | 50 wt. | 120 | 6 | 3:1 | 80.1 | 62.3 |
| | | stage | % | | | | | |
| | | leaching, | H₂SO₄ | | | | | |
| | | followed | | | | | | |
| | | by nickel | | | | | | |
| | | refining | | | | | | |
| | | with LIX- | | | | | | |
| | | 84I | | | | | | |
| C. Ex. | PGS | First | EDTA | 140 | 6 | 3:1 | 19 | 85 |
| 13 | without | stage | | | | | | |
| | salt | leaching | | | | | | |
| | roasting | | | | | | | |
| C. Ex. | PGS | First | H₂SO₄ | 120 | 6 | 3:1 | 25 | 81 |
| 14 | without | stage | | | | | | |
| | salt | leaching | | | | | | |
| | roasting | | | | | | | |

From Table 2, it is observed that the integration of the salt roasting process, the first stage of the leaching and the second stage of the leaching, advantageously improves the recovery efficiency of the nickel from the pulverized gasifier slag. In experiment 1 (Exp. 1), the gasifier slag undergoes the salt roasting and water leaching process to increase the oxidation state of the metal present in the gasifier slag and by filtration, the soluble metal drains along with the solution to obtain the solid phase. The solid phase of the gasifier slag was further pulverized to obtain the pulverized gasifier slag for extracting the nickel.

In experiment 2 (Exp. 2), the pulverized gasifier slag obtained in experiment 1 undergoes the first stage of leaching using EDTA as a leaching agent and the resulting nickel was analyzed to estimate the recovery rate and the purity of the extracted nickel. Example 1 to Example 5 shows the first stage of leaching using EDTA and Example 6 shows the first stage and second stage of leaching using EDTA. It was observed from Experiment 2 and Example 1 to Example 6 that the combination of the first-stage leaching and the second-stage leaching process recovers 15% of more nickel from the pulverized gasifier slag obtained from Experiment 1 (salt roasting) as compared to the single stage of leaching. Similarly, in Experiment 3, the pulverized gasifier slag obtained in Experiment 1 undergoes the first stage of leaching using the acidic solution (H₂SO₄) as a leaching agent. The resulting recovered nickel was analyzed to estimate the recovery rate and the purity of the extracted nickel. In Example 7, 50 wt. % of HNO₃ acidic solution was used to extract the nickel from the pulverized gasifier slag and using a single stage of leaching. Likewise, in Example 8 to Example 11, first stage of leaching used to extract the nickel by varying the wt. % of H₂SO₄ (20% and 50%), the water-to-feed ratio, leaching time and temperature respectively, whereas in Example 12, the residue (first solid residue) of the first leaching step undergoes the second stage of leaching to further recover the nickel from the residue. It is evidently observed that the recovery rate of nickel in example 12 was 19% more than the recovery rate of Experiment 3 and Example 7 to Example 11.

In experiment 4, the first stage of leaching and the second stage of leaching were carried out in accordance with the present disclosure, in which both EDTA and acidic solution (H₂SO₄) were used as a leaching agent. In the first stage of leaching, EDTA was used to recover the nickel from the pulverized gasifier slag (obtained from Experiment 1) and the remaining residue (1^{st} solid residue) undergoes the second stage of leaching using H₂SO₄ as a leaching agent. The second stage of leaching was followed by the nickel refining process using LIX-841 as an organic solvent and subsequently by filtration and precipitation to obtain the nickel from the 1^{st} solid residue.

The obtained result clearly shows the betterment of the process carried out in Experiment 4 in accordance with the present disclosure than the process carried out in Experiment 2 (using only EDTA) and Experiment 3 (using only acidic solution). The result shows 57% more Nickel recovery rate than Experiment 2 and 41% more than Experiment 3.

Comparative Examples 13 and 14 do not show adequate results as the gasifier slag did not undergo the salt-roasting step and two stages of leaching as disclosed in the present disclosure.

### TECHNICAL ADVANCEMENTS

The present disclosure described herein above has several technical advantages including, but not limited to, the process (1000) for extraction of nickel from gasifier slag, that;
consumes minimum chemicals and additives;
achieves nickel production with a purity of up to 98.9%, ensuring high-quality output and superior performance;
is simple to perform and energy efficient;
recycles all intermediate streams and thus makes the process commercially viable; and
maximizes the recovery of nickel from the complex gasifier slag feed.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A process (1000) for extracting nickel from gasifier slag, said process (1000) comprising the following steps:
i. leaching (300) a pulverized gasifier slag (280) with a chelating agent (360) and water at a first predetermined temperature for a first predetermined time, followed by filtering (350) to obtain a first leachate solution comprising an aqueous nickel-chelating agent complex and a first solid residue (380);
ii. precipitating (400) said first leachate solution comprising said aqueous nickel-chelating agent complex by using a first acidic solution (460), followed by filtering (450) to obtain a precipitated chelating agent (490) and a second leachate solution (470) comprising nickel-containing aqueous solution;
iii. leaching (500) said first solid residue (380) in a second acidic solution (560) at a second predetermined temperature for a second predetermined time under continuous stirring followed by filtering (550) to obtain a third leachate solution comprising an aqueous nickel-acid complex and a second solid residue (580);
iv. treating (600) said third leachate solution comprising said aqueous nickel-acid complex by using an organic solvent (790) to obtain a first biphasic mixture comprising an organic layer of a nickel-solvent complex (670) and an aqueous layer (690);
v. separating (650) said organic layer (670) of a nickel-solvent complex and treating (700) by using a third acidic solution (760) to obtain a second biphasic mixture comprising a nickel-containing aqueous phase and said organic solvent phase (790);
vi. separating (750) nickel-containing aqueous phase from said second biphasic mixture to obtain a separated nickel-containing aqueous phase (770);
vii. treating (800) said second leachate solution (470) obtained in step ii) and said separated nickel-containing aqueous phase (770) obtained in step vi) by using an alkali hydroxide (860) under continuous stirring to obtain a slurry comprising a precipitate of nickel hydroxide (870) and an aqueous solution (890); and
viii. separating (850) said nickel hydroxide precipitate (870) followed by drying (900) and calcinating (950) at a third predetermined temperature for a third predetermined time period to obtain nickel (970) in the form of nickel oxide.

2. The process (1000) as claimed in claim 1, wherein said pulverized gasifier slag (280) has a particle size of less than 45 μm.

3. The process (1000) as claimed in claim 1, wherein said pulverized gasifier slag is obtained by:
a. roasting (100) a gasifier slag with an alkali salt at a temperature in the range of 800° C. to 1100° C. for a time period in the range of 1 hour to 5 hours in the presence of air to obtain a roasted slag; and
b. leaching (200) said roasted slag in water heated at a temperature in the range of 60° C. to 120° C. for a time period in the range of 1 hour to 4 hours, followed by filtering (250) and pulverizing to obtain said pulverized gasifier slag (280) enriched with nickel and a solution (290) containing alkali metal salts.

4. The process (1000) as claimed in claim 3, wherein said alkali salt (30) is at least one selected from the group consisting of sodium carbonate (Na₂CO₃), sodium hydroxide (NaOH) and sodium sulfate (Na₂SO₄).

5. The process (1000) as claimed in claim 1, wherein
said precipitated chelating agent (490) obtained in step ii is recycled to step i for the extraction of nickel from said pulverized gasifier slag (280);
said aqueous layer (690) obtained in step iv is recycled to step iii for extracting nickel from said first solid residue (380);
said organic solvent phase (790) obtained in step v is recycled to step iv for treating (600) said third leachate solution comprising said aqueous nickel-acid complex; and
said aqueous solution (890) obtained in step vii is recycled to step i for extracting nickel from said pulverized gasifier slag (280).

6. The process (1000) as claimed in claim 1, wherein leaching of said pulverized gasifier slag (280) in said chelating agent (360) is carried out by maintaining pH in the range of 8 to 10.

7. The process (1000) as claimed in claim 1, wherein
wherein a weight ratio of said pulverized gasifier slag (280) to said chelating agent (360) is in the range of 1:1 to 5:1;
wherein a weight ratio of said pulverized gasifier slag (280) to water in said step (i) is in the range of 1:2 to 1:5; and
wherein a weight ratio of said first solid residue to said second acidic solution in said step (iii) is in the range of 1:2 to 1:5.

8. The process (1000) as claimed in claim 1, wherein the amount of said second acid is in the range of 20 wt % to 60 wt % with respect to the total weight of said second acidic solution.

9. The process (1000) as claimed in claim 1, wherein said precipitated chelating agent (490) is recovered by maintaining the pH of said first leachate solution comprising said aqueous nickel-chelating agent complex in the range of 1 to 5; wherein said pH is maintained by using said first acidic solution (460).

10. The process (1000) as claimed in claim 1, wherein said first solid residue (380) and said second solid residue (580) contain nickel, silica, alumina, calcium, iron and magnesium.

11. The process (1000) as claimed in claim 1, wherein said chelating agent (360) is selected from the group consisting of Ethylenediaminetetraacetic acid (EDTA), Dimethylglyoxime (DMG) and Diethylenetriamine penta acetic acid (DTPA).

12. The process (1000) as claimed in claim 1, wherein said first predetermined temperature is in the range of 60° C. to 160° C. and said first predetermined time period is in the range of 2 hours to 8 hours.

13. The process (1000) as claimed in claim 1, wherein said first acidic solution (460), said second acidic solution (560) and said third acidic solution (760) are independently selected from nitric acid (HNO₃), sulphuric acid (H₂SO₄) and mixtures thereof.

14. The process (1000) as claimed in claim 1, wherein said alkali hydroxide (860) is at least one selected from the group consisting of sodium hydroxide (NaOH), magnesium hydroxide (Mg(OH)₂) and potassium hydroxide (KOH).

15. The process (1000) as claimed in claim 1, wherein said organic solvent (790) is used as an extraction agent for extracting nickel from said third leachate solution comprising said aqueous nickel-acid complex, wherein said organic solvent (790) is selected from 2-hydroxy-5-nonylaceto-phenone oxime, 1-phenyl-3-hydroxy-4-oxime-5-pyrazolone, 1-phenyl-3,5-dimethyl-4-oxime-5-pyrazolone and 1-phenyl-3-methyl-4-oxime-5-pyrazolone.

16. The process (1000) as claimed in claim 1, wherein said nickel is recovered from said nickel-solvent complex (670) by lowering the pH of said nickel-solvent complex in the range of 1 to 5 by using said third acidic solution.

17. The process (1000) as claimed in claim 1, wherein said precipitation (800) in step vii is carried out by maintaining pH in the range of 8 to 12 to obtain said slurry comprising said precipitate of nickel hydroxide.

18. The process (1000) as claimed in claim 1, wherein said second predetermined temperature is in the range of 40° C. to 140° C. and said second predetermined time period is in the range of 2 hours to 6 hours.

19. The process (1000) as claimed in claim 1, wherein said third predetermined temperature is in the range of 100° C. to 300° C. and said third predetermined time period is in the range of 1 hour to 5 hours.

20. The process (1000) as claimed in claim 1, wherein said process is a continuous process of extraction of said nickel in the oxide form from said pulverized gasifier slag (280).

21. The process (1000) as claimed in claim 1, wherein said extracted nickel has a recovery rate in the range of 15% to 80% and purity in the range of 50% to 99%.
